(19) United States
(12) Patent Application Publication
(10) Pub. No.: US 2007/0081252 A1
(43) Pub. Date: Apr. 12, 2007

(54) Single panel reflective-type color optical engine

(76) Inventors: Shu-I Lin, Taipei City (TW); Ching-Fuh Lin, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/196,313

(22) Filed: Aug. 4, 2005

(51) Int. Cl. G02B 27/10

(52) U.S. Cl. 359/618

(57) ABSTRACT

A single panel reflective-type color optical engine makes use of a grating matched with a reflecting mirror set for adjusting the traveling directions of three primary color lights or at least a beam-splitting rotating disk and a reflecting mirror to split an incident light into the three primary color lights and separately adjusts their reflected directions and orders, or makes use of three reflecting mirrors with continually varying angles to reflect three primary color lights to adjust their reflected directions and orders, thereby simultaneously projecting the three primary color lights onto different regions of a single panel in the red-green-blue, green-blue-red, and then blue-red-green order. The single panel reflective-type color optical engine can apply to LCOS and DLP reflective-type projection systems, and has the advantages of high brightness, good uniformity, small size, and low price.

### BACKGROUND OF THE INVENTION

1. Field of the Invention

The present invention relates to a single panel color projection equipment and, more particularly, to a single panel reflective-type color optical engine applicable to liquid crystal on silicon (LCOS) and digital light processing (DLP) reflective-type projection devices.

2. Description of Related art

Along with the progress of science and technology, people more and more demand larger and more comfort display frames. In addition to plasma displays, projection systems are the mainstream of breaking through the bottleneck of display size. Existent projection equipments have been greatly improved in performance, cost, size, and weight.

In a liquid crystal (LC) projection display, an external metal halide lamp or ultra high pressure (UHP) lamp is used to produce a powerful light. For the three-LC-panel design, the intense light passes through a beam splitter to form three light beams of red (R), green (G), and blue (B) colors, which are transmitted through or reflected from LC panels of R, G, and B, respectively. A signal source is A/D converted, modulated and then applied to the LC panels to control the on or off mode of LC units, thereby controlling the on or off state of the optical path. After beam combination and magnification by an optical lens lens set, the image is displayed on a large screen. In another design of single LC panel projector, R, G and B lights are alternately projected onto the LC panel by means of color rotation to have only a color at any time. Two thirds of light will get lost in this color rotation manner. The single LC panel projector has a small size, a light weight, and convenient operation and portability and is cheap, but has the disadvantages of short lifetime of the light source, nonuniform color, and low resolution.

In order to solve the disadvantages of the single LC panel projection technique, Philips has proposed a spiral color method, in which an optical system is formed by assembling three rectangular prisms and a plurality of reflecting mirrors and lenses. This method mainly makes use of rotation of the prisms to split a white light into three light bands of R, G and B colors moving in the vertical direction. Angles of the prisms will jump discontinuously when illuminating and intersecting the light bands. These light bands are generated through the arrangement of the mirrors and lenses. In this spiral color method, it is necessary to exploit synchronous actions of the three prisms to have the three colors simultaneously existing on the single LC panel and continuously varying in the R-G-B order. However, it is difficult to keep synchronization of the three prisms for a long time. Besides, because the optical path of this optical system is long, and the optical path passing through the prisms is also long, there will be different temperature effects at the center and two sides. Difference of the refractive index will cause the problem of the brightness of the projection light and thus lead to a nonuniform light distribution.

The present invention aims to propose a single panel reflective-type color optical engine without the need of using rectangular prisms. In addition to enhancing the projection brightness, the single panel reflective-type color optical engine can also have a better uniformity of light distribution.

### SUMMARY OF THE INVENTION

An object of the present invention is to provide a single panel reflective-type color optical engine, in which the three primary color lights are projected onto a single panel at the same time to enhance the brightness of a single panel color projection device. Moreover, because the optical path is short, the present invention has less problem of temperature effect and thus has a better uniformity of light distribution. Therefore, the present invention has the advantages of high brightness, better uniformity, small size, and low price.

Another object of the present invention is to provide a single panel reflective-type color optical engine, which can effectively enhance the brightness of a single panel color projection device, with a maximal enhancement of three times of a conventional single panel color projection device. Light loss due to color rotation can be avoided so that the brightness of the single panel projection device is commensurate with that of the three panel projection device.

Another object of the present invention is to provide a single panel reflective-type color optical engine without the use of color filter.

To achieve the above objects, an embodiment of the present invention comprises a light source, a grating, and at least a reflecting mirror. The light source provides an incident light incident to the grating, which reflects the incident light into three primary color lights. The reflecting mirror set is located on optical paths of the three primary color lights for separately adjusting traveling directions of the three primary color lights to simultaneously project the three primary color lights onto a panel. The arrangement order of the three primary color lights is adjusted by the reflecting mirror.

Another embodiment of the present invention comprises a light source, a first beam-splitting color wheel, a second beam-splitting color wheel, and a reflecting mirror. The light source provides an incident light incident to the first beam-splitting color wheel with three evenly divided beam-splitting regions thereon, each beam-splitting region being capable of splitting a corresponding primary color light. The first beam-splitting color wheel is used to split a first primary color light of the incident light from the other two primary color lights. The second beam-splitting color wheel has also three evenly divided beam-splitting regions thereon, each beam-splitting region being capable of reflecting a corresponding primary color light and transmitting the other primary color lights. The second beam-splitting color wheel rotates synchronously with the first beam-splitting color wheel to reflect a second primary color light in the other two primary color lights and transmit a third primary color light. The reflecting mirror is used to reflect the split third primary color light to simultaneously project the third primary color light onto the panel with the first and second primary color lights.

Another embodiment of the present invention comprises a light source, a beam-splitting color wheel, and a reflecting mirror. The light source is used to provide an incident light incident to the beam-splitting color wheel, which has a beam-splitting region of a first primary color light, a beam-splitting region of a second primary color light, and a beam-splitting region of a third primary color light evenly divided thereon. The beam-splitting color wheel makes use of the beam-splitting region of the first primary color light to split the first primary color light of the incident light from the other two primary color lights. The reflecting mirror reflects the other two primary color lights to the beam-splitting region of the second primary color light for transmitting the second primary color light and reflecting the third primary color light back to the reflecting mirror for reflection again so that the third primary color light can be simultaneously projected onto the panel with the first and second primary color lights.

Another embodiment of the present invention comprises a light source, a beam-splitter, and three reflecting components. The light source is used to provide an incident light incident to the beam splitter. The beam splitter splits the incident light into three primary color lights. The three reflecting components separately adjust traveling directions of the three primary color lights to simultaneously project the three primary color lights onto the panel.

### BRIEF DESCRIPTION OF THE DRAWINGS

The various objects and advantages of the present invention will be more readily understood from the following detailed description when read in conjunction with the appended drawing, in which:

FIGS. 1 to 3 are structure diagrams according to a first embodiment of the present invention;

FIGS. 4 to 6 are structure diagrams according to a second embodiment of the present invention;

FIGS. 7 to 10 are structure diagrams according to a third embodiment of the present invention;

FIG. 11 is a structure diagram according to a fourth embodiment of the present invention;

FIG. 12 is a structure diagram according to a fifth embodiment of the present invention;

FIG. 13 is a structure diagram according to a sixth embodiment of the present invention;

FIG. 14 is a structure diagram according to a seventh embodiment of the present invention;

FIG. 15 is a structure diagram according to an eighth embodiment of the present invention;

FIG. 16 is a structure diagram according to a ninth embodiment of the present invention;

FIG. 17 is a structure diagram according to a tenth embodiment of the present invention; and

FIG. 18 is a structure diagram according to an eleven embodiment of the present invention.

### DETAILED DESCRIPTION OF THE PREFERRED EMBODIMENTS

The present invention proposes a single panel reflective-type color optical engine to project three primary color lights onto a panel at the same time, which can effectively enhance the brightness of a single panel color projection device, with a maximal enhancement of three times of a conventional single panel color projection device. The brightness of the single panel projection device is commensurate with that of the three panel projection device. Moreover, because the optical path is short, the present invention has less problem of temperature effect and thus has a better uniformity of light distribution.

The present invention has many different embodiments of color optical engine. Each embodiment adjusts the reflection directions and arrangement order of three primary color lights to let the three primary color lights be simultaneously projected onto a panel, each primary color occupying about one-third of the area of the panel and be continuously projected onto a LCOS reflective-type LC panel or a DLP panel in the red-green-blue, green-blue-red, and then blue-red-green order. The present invention will be exemplified below with various different embodiments.

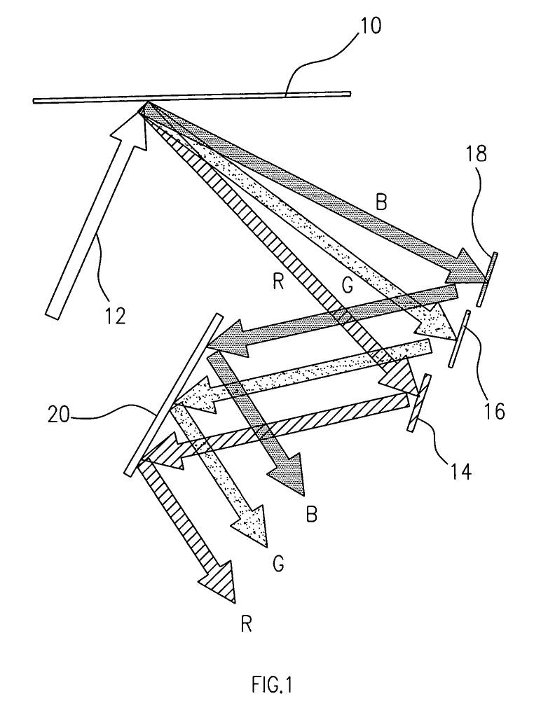

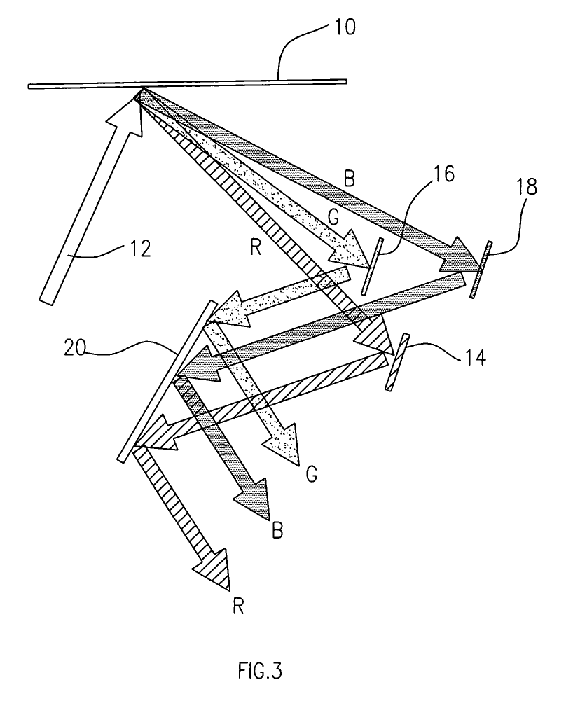

FIGS. 1 to 3 are structure diagrams according to a first embodiment of the present invention. As shown in FIG. 1, a single panel reflective-type color optical engine comprises a grating 10 and at least a reflecting mirror set for adjusting traveling directions of the three primary color lights. When a light source provides an incident light 12 incident to the grating 10, which reflects and splits the incident light into three lights of the primary colors R, G and B. Next, the three primary color lights of R, G, and B are incident to a red-reflecting mirror 14, a green-reflecting mirror 16, and a blue-reflecting mirror 18, respectively. The three reflecting mirrors 14, 16, and 18 adjust the reflected directions and arrangement order of the three primary color lights of R, G, and B split by the grating 10 to let the three primary color lights of R, G, and B be parallel incident to a reflecting mirror 20. The three primary color lights of R, G, and B are finally simultaneously projected onto a panel (not shown), each occupying about one-thirds of the area of the panel.

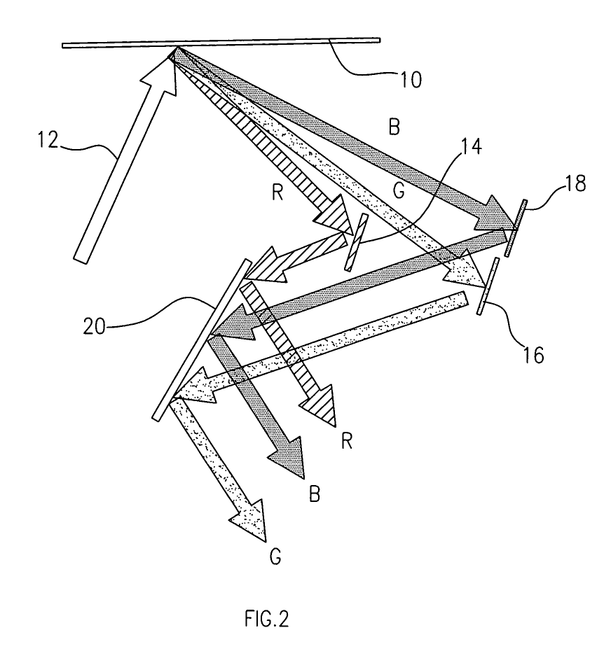

In order to adjust the arrangement order of the three primary color lights of R, G, and B, the angles and positions of the reflecting mirror set composed of the red-reflecting mirror 14, the green-reflecting mirror 16, and the blue-reflecting mirror 18 are used to adjust traveling directions of the three primary color lights to let the arrangement order of the three primary color lights reflected to the reflecting mirror 20 be in the G-B-R (B-R-G) order shown in FIG. 2 (3). In this way, the three primary color lights will be continuously projected on the panel in the R-G-B, G-B-R, and then B-R-G order.

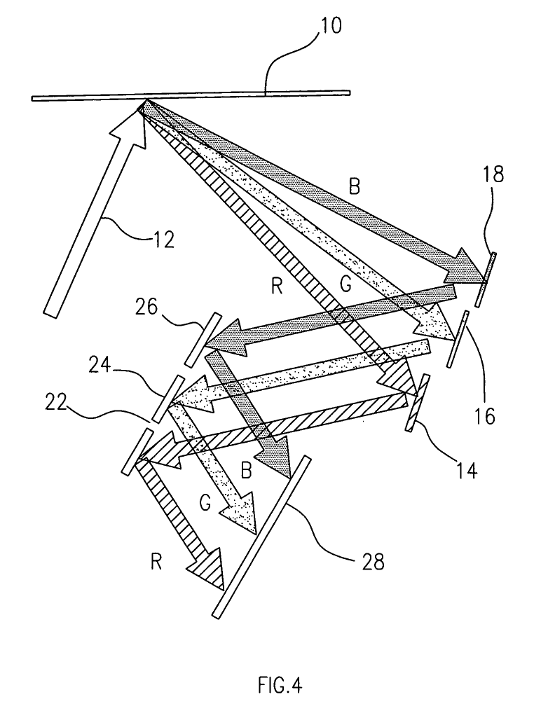

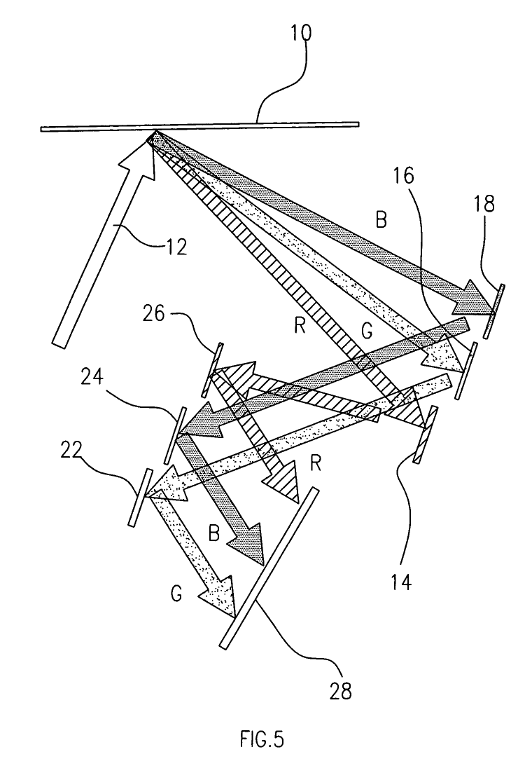

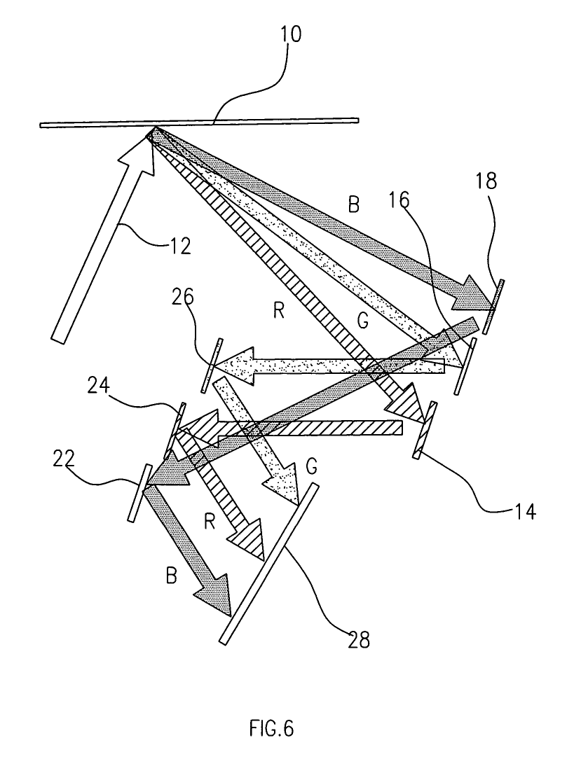

In the above first embodiment, the reflecting mirror 20 is used to reflect the three primary color lights to the panel. FIGS. 4 to 6 are structure diagrams according to a second embodiment of the present invention. A second reflecting mirror set composed of a red-reflecting mirror 22, a green-reflecting mirror 24, and a blue-reflecting mirror 26 is used to replace the above reflecting mirror 20. In this second embodiment, the reflected directions of the red-reflecting mirror 14, the green-reflecting mirror 16, and the blue-reflecting mirror 18 of the above first reflecting mirror set are changed to let the arrangement of the three primary color lights incident to the second reflecting mirror set be in the R-G-B, G-B-R, and then B-R-G order. The arrangement positions of the red-reflecting mirror 22, the green-reflecting mirror 24, and the blue-reflecting mirror 26 of the second reflecting mirror set are changed are changed to let each primary color light be reflected by the red-reflecting mirror 22, the green-reflecting mirror 24, and the blue-reflecting mirror 26, respectively, thereby adjusting the reflected directions and arrangement order of the three primary color lights of R, G, and B. The three primary color lights of R, G, and B will be continuously projected onto a panel 28 in the R-G-B, G-B-R, and then B-R-G order.

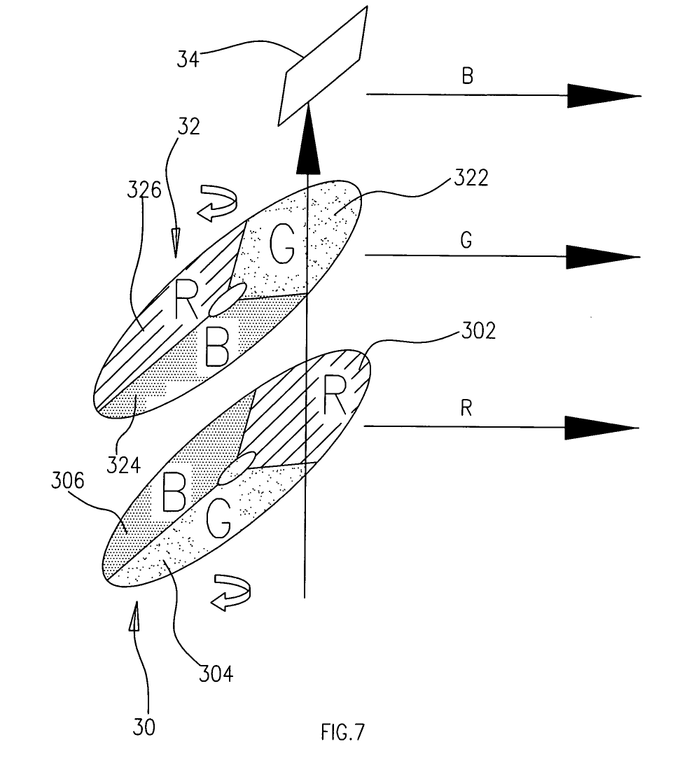

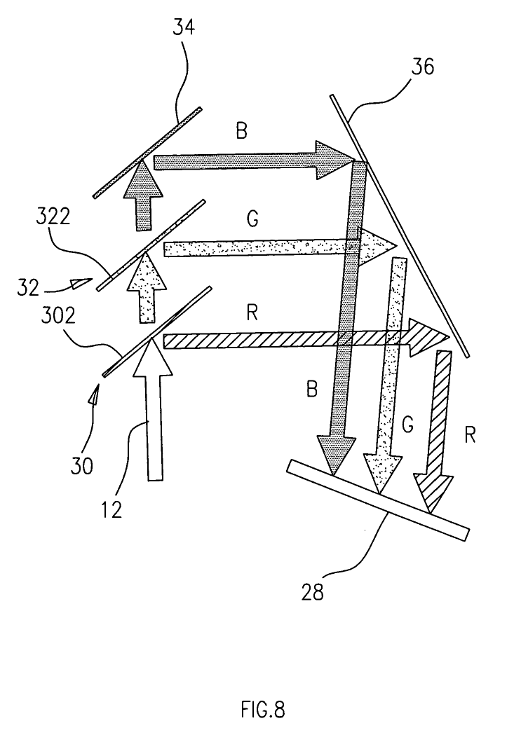

FIGS. 7 to 10 are structure diagrams according to a third embodiment of the present invention. As shown in FIG. 7, a single panel reflective-type color optical engine comprises two parallel beam-splitting color wheels 30 and 32 and a reflecting mirror 34. A red beam-splitting region 302, a green beam-splitting region 304, and a blue beam-splitting region 306 are evenly divided on the first beam-splitting color wheel 30. Each of the beam-splitting regions 302, 304, and 306 can reflect a corresponding primary color light and transmit the other primary color lights. That is, the red beam-splitting region 302 can reflect the red light and transmit the green and blue lights. The rest may be deduced by analogy. Reference is made to FIGS. 7 and 8. When a light source provides an incident light 12 to the first beam-splitting color wheel 30, the first beam-splitting color wheel 30 will make use of the red beam-splitting region 302 to reflect the red light of the incident light and transmit the remaining green and blue lights to the second beam-splitting color wheel 32. A green beam-splitting region 322, a blue beam-splitting region 324, and a red beam-splitting region 326 are evenly divided on the second beam-splitting color wheel 32. Each of the beam-splitting regions 322, 324, and 326 can reflect a corresponding primary color light and transmit the other primary color light. The second beam-splitting color wheel 32 rotates synchronously with the first beam-splitting color wheel 30 to let the green and blue lights transmitted by the first beam-splitting color wheel 30 be incident to the green beam-splitting region 322 of the second beam-splitting color wheel 32, thereby reflecting the green light and transmitting the blue light to the reflecting mirror 34. The blue light is reflected by the reflecting mirror 34 and then reflected by a larger reflecting mirror 36 along with the red and green lights. Therefore, the red, green and blue lights are simultaneously projected onto the panel 28 in the R-G-B order.

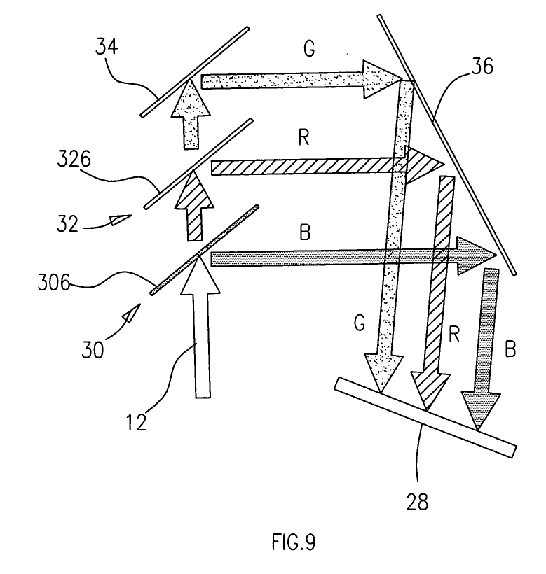

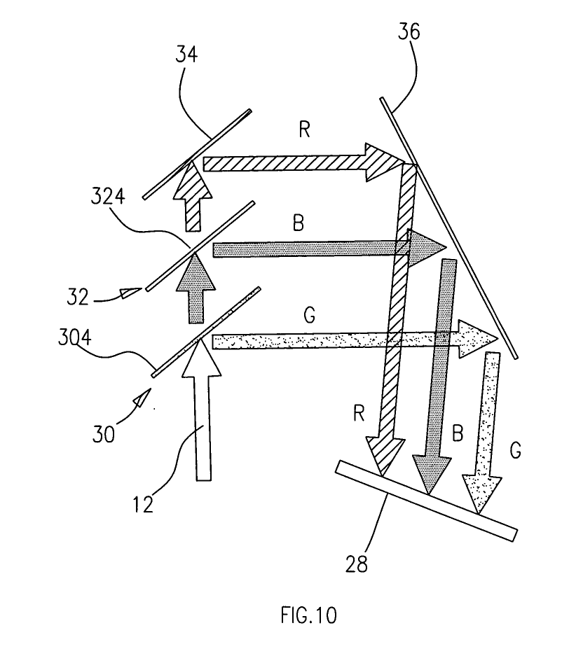

In order to continuously project the above three primary color lights of R, G, and B onto the panel 28 in the R-G-B, B-R-G, and then G-B-R order, the first and second beam-splitting color wheels 30 and 32 rotate synchronously to reflect two of the three primary color lights of R, G, and B. In other words, as shown in FIG. 9, the first and second beam-splitting color wheels 30 and 32 rotate synchronously. The incident light 12 is incident to the blue beam-splitting region 306 of the first beam-splitting color wheel 30 to reflect the blue light and transmit the remaining red and green lights to the red beam-splitting region 326 of the second beam-splitting color wheel 32. The red light is then reflected, while the green light is transmitted to and then reflected by the reflecting mirror 34. The green light can thus be simultaneously projected onto the panel 28 along with the blue and red lights in the B-R-G order. Similarly, as shown in FIG. 10, when the first beam-splitting color wheel 30 rotates to the green beam-splitting region 304 and the second beam-splitting color wheel 32 rotates to the blue beam-splitting region 324, the lights projected onto the panel 28 will be in the G-B-R order.

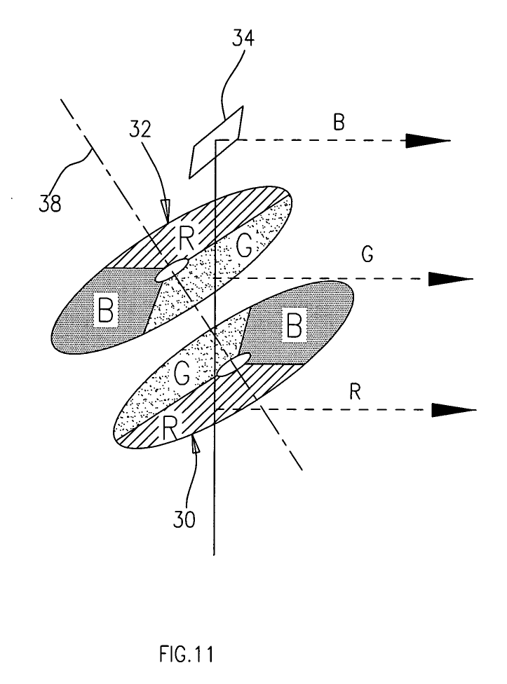

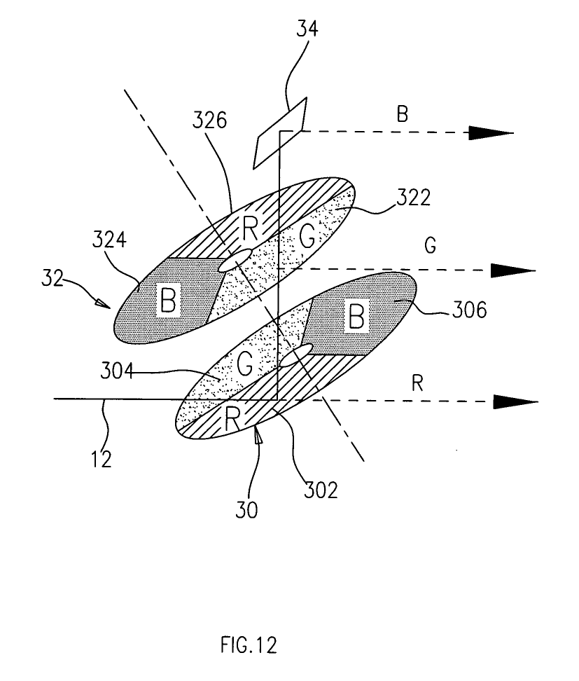

FIG. 11 is a structure diagram according to a fourth embodiment of the present invention. The above first and second beam-splitting color wheels 30 and 32 are located on the same axis of rotation 38 for synchronous rotation. Besides, each beam-splitting region on the first beam-splitting color wheel 30 can be designed to transmit a corresponding primary color light and reflect the remaining two primary color lights. FIG. 12 is a structure diagram according to a fifth embodiment of the present invention. The red beam-splitting region 302, the green beam-splitting region 304, and the blue beam-splitting region 306 of the first beam-splitting color wheel 30 transmit the corresponding red, green, and blue lights. As shown in FIG. 12, when the incident light 12 is incident to the red beam-splitting region 302 of the first beam-splitting color wheel 30, the red light of the incident light 12 will be transmitted and the remaining green and blue lights will be reflected to the second beam-splitting color wheel 32. The green beam-splitting region 322 of the second beam-splitting color wheel 32 reflects the green light and transmits the blue light to the reflecting mirror 34. The blue light can thus be reflected by the reflecting mirror 34 and then be simultaneously projected onto a panel (not shown) with the green and red lights in an appropriate order. Besides, through synchronous rotation of the first and second beam-splitting color wheels 30 and 32, the three primary color lights of R, G, and B can be continuously projected onto the panel in the R-G-B, B-R-G, and then G-B-R order.

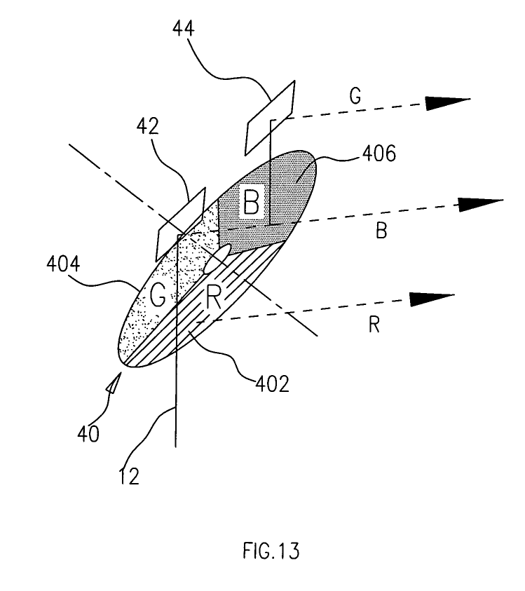

All the above third, fourth, and fifth embodiments use two beam-splitting color wheels. The present invention can also use a single beam-splitting color wheel. FIG. 13 is a structure diagram according to a sixth embodiment of the present invention. A red beam-splitting region 402, a green beam-splitting region 404, and a blue beam-splitting region 406 are evenly divided on a beam-splitting color wheel 40. When an incident light 12 is incident to the red beam-splitting region 402 of the beam-splitting color wheel 40, the red beam-splitting region 402 will reflect the red light in the incident light 12 and transmit the remaining blue and green lights to a first reflecting mirror 42. The blue and green lights are reflected by the first reflecting mirror 42 to the blue beam-splitting region 406 of the beam-splitting color wheel 40 to transmit the blue light and reflect the green light to a second reflecting mirror 44, which reflects the green light. The green light is thus simultaneously projected onto a panel along with the red and blue lights. Therefore, this sixth embodiment makes use of rotation of the beam-splitting color wheel 40 and the functions of the two reflecting mirrors 42 and 44 to continuously project the three primary color lights onto the panel in the R-G-B, G-B-R, and then B-R-G order.

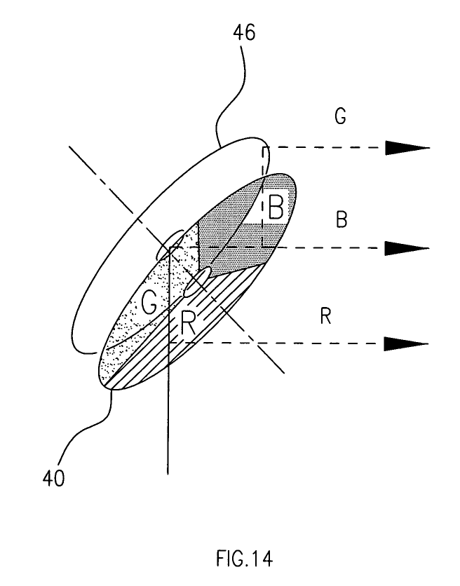

Besides, the first reflecting mirror 42 and the second reflecting mirror 44 used in this sixth embodiment can be simultaneously fabricated to form a larger reflecting mirror or a larger circular disc reflecting mirror 46. FIG. 14 is a structure diagram according to a seventh embodiment of the present invention, in which the circular disc reflecting mirror 46 is used to reflect all the incident lights. The detailed optical paths are the same as those in the sixth embodiment and thus won't be further described.

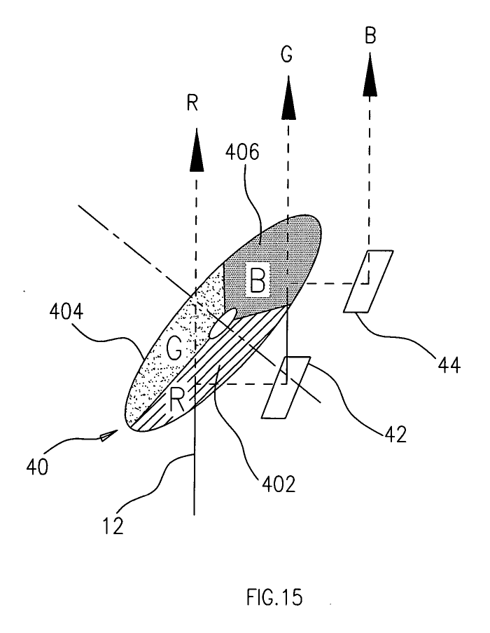

FIG. 15 is a structure diagram according to an eighth embodiment of the present invention. When an incident light 12 is incident to the red beam-splitting region 402 of the beam-splitting color wheel 40, the red beam-splitting region 402 will transmit the red light in the incident light and reflect the remaining blue and green lights to the first reflecting mirror 42, which reflects the blue and green lights to the blue beam-splitting region 406 of the beam-splitting color wheel 40. The blue beam-splitting region 406 will transmit the green light and reflect the blue light to the second reflecting mirror 44, which reflects the blue light. The blue light can thus be simultaneously projected onto a panel along with the red and green lights.

In the above beam-splitting color wheel, the red, green, and blue beam-splitting regions can be spirally distributed. When the beam-splitting color wheel rotates, the three primary color lights are continuously projected onto the panel. The red, green, and blue lights will simultaneously be projected onto different regions of the panel. The projected regions continuously move to and fro on the panel. For instance, the red light continuously scan from one end of the panel to the other end of the panel, so do the blue and green lights.

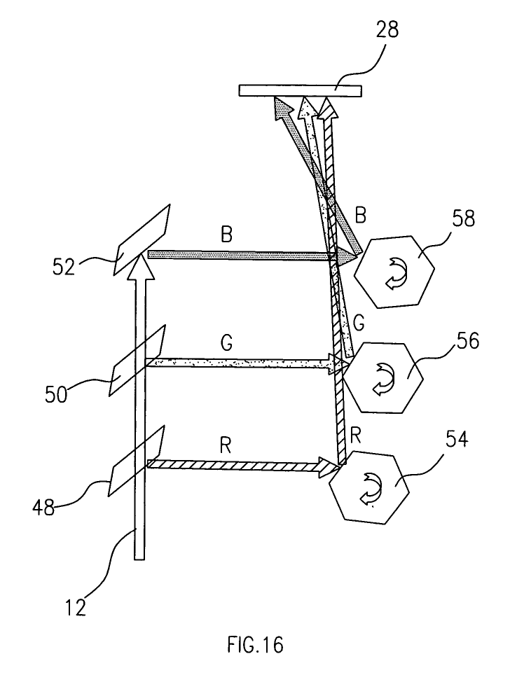

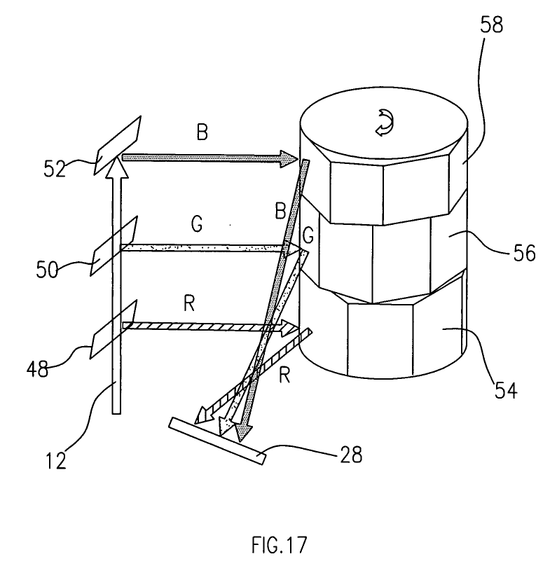

FIG. 16 is a structure diagram according to a ninth embodiment of the present invention. When the incident light 12 is incident to a first beam splitter 48, the red light in the incident light will be reflected while the remaining green and blue lights will be transmitted to a second beam splitter 50. The second beam splitter 50 then reflects the green light and transmits the blue light to a third beam splitter 52, which reflects the blue light. The red light, green light, and blue light are reflected to corresponding reflecting polygon mirrors 54, 56, and 58. After reflected by these reflecting polygon mirrors 54, 56, and 58, the blue light is simultaneously projected onto the panel 28 along with the green and red lights in an appropriate order. Besides, through change of the reflection positions of the red-, green-, and blue-reflecting polygon mirrors 54, 56, and 58, the arrangement order of the three primary color lights can be adjusted. The above synchronously rotating red-, green-, and blue-reflecting polygon mirrors 54, 56, and 58 can be fabricated on the same axis of rotation for synchronous rotation. FIG. 17 is a structure diagram according to a tenth embodiment of the present invention. Through rotation of the reflecting polygon mirrors 54, 56, and 58, when the three primary color lights are continuously projected onto the panel, the red, green, and blue lights will simultaneously illuminate different regions of the panel. The illuminated regions will continuously move to and fro on the panel. For instance, the red light continuously scan from one end of the panel to the other end of the panel, so do the blue and green lights.

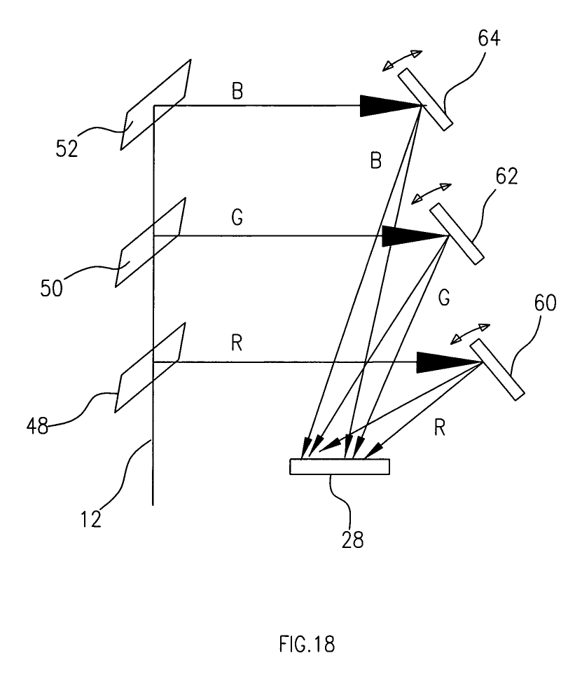

In the above ninth embodiment, the reflecting prisms are used as reflecting components. FIG. 18 is a structure diagram according to an eleventh embodiment of the present invention, in which three movable reflecting mirrors 60, 62, and 64 are used to replace the above reflecting polygon mirrors to facilitate adjustment of the reflected directions and arrangement order of the three primary color lights so that the three primary color lights can be simultaneously projected onto the panel 28. The three reflecting mirrors 60, 62, and 64 for reflecting the three primary color lights vibrate to and fro. When the three primary color lights are continuously projected onto the panel, the red, green, and blue lights will simultaneously illuminate different regions of the panel. The illuminated regions will continuously move to and fro on the panel. For instance, the red light continuously scan from one end of the panel to the other end of the panel, so do the blue and green lights.

To sum up, in any of the above embodiments, the single panel reflective-type color optical engine of the present invention can continuously project three primary color lights onto a panel at the same time according to different arrangement orders to enhance the brightness of a single panel color projection device. Moreover, because the optical paths in optical components are short, the temperature effect at the center and two sides are close. There is no brightness problem of the projection light due to difference of the refractive index. That is, the present invention has no problem of temperature effect and thus has a better uniformity of light distribution. Therefore, the present invention has the advantages of high brightness, good uniformity, small size, and cheap price.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A single panel reflective-type color optical engine for splitting an incident light into three primary color lights and simultaneously said three primary color lights onto a single panel, said single panel reflective-type color optical engine comprising:
a light source for providing an incident light;
a grating for reflecting and splitting said incident light into three primary color lights; and
at least a reflecting mirror set located on optical paths of said three primary color lights for separately adjusting traveling directions of said three primary color lights to simultaneously project said three primary color lights onto said panel.

2. The single panel reflective-type color optical engine as claimed in claim 1, wherein said reflecting mirror set reflects and adjusts said three primary color lights in the red-green-blue, green-blue-red, and then blue-red-green order to project said three primary color lights onto said panel, and the arrangement order of said three primary color lights is adjusted by said reflecting mirror set.

3. The single panel reflective-type color optical engine as claimed in claim 2, wherein said reflecting mirror set comprises three reflecting mirrors for respectively reflecting red, green and blue lights and another reflecting mirror, said reflecting mirrors for reflecting the red, green and blue lights respectively adjust reflected directions and orders of said three primary color lights split by said grating to let said three primary color lights be simultaneously and parallel incident onto said another reflecting mirror and then be projected onto said panel.

4. The single panel reflective-type color optical engine as claimed in claim 2, wherein said reflecting mirror set comprises a first reflecting mirror set and a second reflecting mirror set each having three reflecting mirrors for respectively reflecting red, green and blue lights, said first and second reflecting mirror sets being used to adjust reflected directions and orders of said three primary color lights split by said grating so as to simultaneously and parallel project said three primary color lights onto said panel.

5. The single panel reflective-type color optical engine as claimed in claim 3, wherein said three reflecting mirrors for reflecting three primary color lights can be simultaneously disposed on a prism, and angles and positions of said three reflecting mirrors are simultaneously through rotation of said prism.

6. The single panel reflective-type color optical engine as claimed in claim 3, wherein said three reflecting mirrors for reflecting three primary color lights are reciprocating mirrors, when said three primary color lights are continuously projected onto said panel, red, green and blue lights will be simultaneously projected onto different regions of said panel, and said projected regions continuously scan said panel to and fro.

7. The single panel reflective-type color optical engine as claimed in claim 1, wherein said panel is a LCOS reflective-type LCD panel or a DLP panel.

8. The single panel reflective-type color optical engine as claimed in claim 1, wherein each said three primary color lights illuminates about ⅓ of said panel.

9. A single panel reflective-type color optical engine for splitting an incident light into three primary color lights and simultaneously said three primary color lights onto a single panel, said single panel reflective-type color optical engine comprising:
a light source for providing an incident light;
a first beam-splitting color wheel with three divided beam-splitting regions thereon, each said beam-splitting region being capable of splitting a corresponding primary color light, said first beam-splitting color wheel being used to split a first primary color light of said incident light from the other two primary color lights;
a second beam-splitting color wheel with three divided beam-splitting regions thereon, each said beam-splitting region being capable of reflecting a corresponding primary color light and transmitting the other primary color lights, said second beam-splitting color wheel rotating synchronously with said first beam-splitting color wheel to reflect a second primary color light in said other two primary color lights and transmit a third primary color light; and
a reflecting mirror for reflecting said split third primary color light to simultaneously project said third primary color light onto said panel with said first and second primary color lights.

10. The single panel reflective-type color optical engine as claimed in claim 9, wherein first and second beam-splitting color wheels rotate synchronously to reflect or transmit two primary color lights in said three primary color lights and continuously project said three primary color lights onto said panel in the red-green-blue, green-blue-red, and then blue-red-green order through the function of said reflecting mirror.

11. The single panel reflective-type color optical engine as claimed in claim 9, wherein said three beam-splitting regions in the clockwise direction of said first beam-splitting color wheel are a beam-splitting region of said first primary color light, a beam-splitting region of said second primary color light, and a beam-splitting region of said third primary color light, respectively, and said corresponding three beam-splitting regions of said second beam-splitting color wheel are a beam-splitting region of said second primary color light, a beam-splitting region of said third primary color light, and a beam-splitting region of said first primary color light, respectively, and said two beam-splitting color wheels can be used to split different primary color lights.

12. The single panel reflective-type color optical engine as claimed in claim 9, wherein each said beam-splitting region on said first beam-splitting color wheel can reflect a corresponding primary color light and transmit the other primary color lights so that said first beam-splitting color wheel can reflect said first primary color light of said incident light and transmit the other two primary color lights.

13. The single panel reflective-type color optical engine as claimed in claim 9, wherein each said beam-splitting region on said first beam-splitting color wheel can transmit a corresponding primary color light and reflect the other primary color lights so that said first beam-splitting color wheel can transmit said first primary color light of said incident light and reflect the other two primary color lights.

14. The single panel reflective-type color optical engine as claimed in claim 9, wherein said first and second beam-splitting color wheels are located on an identical axis of rotation for synchronous rotation.

15. The single panel reflective-type color optical engine as claimed in claim 9, wherein red, green, and blue beam-splitting regions of said first and second beam-splitting color wheels are spirally distributed, when said beam-splitting color wheels rotate to continuously project said three primary color lights onto said panel, red, green, and blue primary color lights are simultaneously projected onto different regions of said panel, and said projected regions continuously scan said panel to and fro.

16. The single panel reflective-type color optical engine as claimed in claim 9, wherein said panel is a LCOS reflective-type LCD panel or a DLP panel.

17. The single panel reflective-type color optical engine as claimed in claim 9, wherein each said three primary color lights illuminates about ⅓ of said panel.

18. A single panel reflective-type color optical engine for splitting an incident light into three primary color lights and simultaneously said three primary color lights onto a single panel, said single panel reflective-type color optical engine comprising:
a light source for providing an incident light;
a beam-splitting color wheel with a beam-splitting region of a first primary color light, a beam-splitting region of a second primary color light, and a beam-splitting region of a third primary color light divided thereon, each said beam-splitting region being capable of splitting said corresponding primary color light, said beam-splitting color wheel making use of said beam-splitting region of said first primary color light to split said first primary color light of said incident light from the other two primary color lights; and
a reflecting mirror for reflecting said other two primary color lights to said beam-splitting region of said second primary color light for transmitting said second primary color light and reflecting said third primary color light back to said reflecting mirror for reflection again so that said third primary color light can be simultaneously projected onto said panel with said first and second primary color lights.

19. The single panel reflective-type color optical engine as claimed in claim 18, wherein said three primary color lights are continuously projected said panel in the red-green-blue, green-blue-red, and then blue-red-green order through rotation of said beam-splitting color wheel and the function of said reflecting mirror.

20. The single panel reflective-type color optical engine as claimed in claim 18, wherein said reflecting mirror further comprises:
a first reflecting mirror for reflecting said two primary color lights to said beam-splitting region of said second primary color light so as to transmit said second primary color light and reflect said third primary color light; and
a second reflecting mirror for reflecting said split third primary color light to simultaneously project said third primary color light onto said panel with said first and second primary color lights.

21. The single panel reflective-type color optical engine as claimed in claim 18, wherein said beam-splitting color wheel makes use of said beam-splitting region of said first primary color light to reflect said first primary color light in said incident light and transmit the other two primary color lights.

22. The single panel reflective-type color optical engine as claimed in claim 18, wherein said beam-splitting color wheel makes use of said beam-splitting region of said first primary color light to transmit said first primary color light in said incident light and reflect the other two primary color lights.

23. The single panel reflective-type color optical engine as claimed in claim 18, wherein red, green, and blue beam-splitting regions of said beam-splitting color wheel are spirally distributed, when said beam-splitting color wheel rotates to continuously project said three primary color lights onto said panel, red, green, and blue primary color lights are simultaneously projected onto different regions of said panel, and said projected regions continuously scan said panel to and fro.

24. The single panel reflective-type color optical engine as claimed in claim 18, wherein said reflecting mirror can be a circular disc reflecting mirror.

25. The single panel reflective-type color optical engine as claimed in claim 18, wherein said panel is a LCOS reflective-type LCD panel or a DLP panel.

26. The single panel reflective-type color optical engine as claimed in claim 18, wherein each said three primary color lights illuminates about ⅓ of said panel.

27. A single panel reflective-type color optical engine for splitting an incident light into three primary color lights and simultaneously said three primary color lights onto a single panel, said single panel reflective-type color optical engine comprising:
a light source for providing an incident light;
a beam splitter for splitting said incident light into three primary color lights; and
three reflecting components located on optical paths of said three primary color lights for separately adjusting traveling directions of said three primary color lights by using corresponding angles of said reflecting components to simultaneously project said three primary color lights onto said panel.

28. The single panel reflective-type color optical engine as claimed in claim 27, wherein said three primary color lights reflected and adjusted by said reflecting components are continuously projected onto said panel in the red-green-blue, green-blue-red, and then blue-red-green order, and the arrangement order of said three primary color lights is adjusted through actions of said reflecting components.

29. The single panel reflective-type color optical engine as claimed in claim 27, wherein said reflecting components can be three cylindrical surfaces of a rotating equilateral cylinder, and red, green, and blue primary color lights are simultaneously projected onto different regions of said panel, and said projected regions continuously scan said panel to and fro when said cylinder rotates to continuously project said three primary color lights onto said panel.

30. The single panel reflective-type color optical engine as claimed in claim 27, wherein said three reflecting components can be three rotating reflecting cylinders.

31. The single panel reflective-type color optical engine as claimed in claim 30, wherein said three rotating cylinders can be manufactured on an identical axis of rotation for synchronous rotation.

32. The single panel reflective-type color optical engine as claimed in claim 27, wherein said three reflecting components are reciprocating mirrors, when said reflecting components vibrate to and fro to continuously project said three primary color lights onto said panel, red, green, and blue primary color lights are simultaneously projected onto different regions of said panel, and said projected regions continuously scan said panel to and fro.

33. The single panel reflective-type color optical engine as claimed in claim 27, wherein said panel is a LCOS reflective-type LCD panel or a DLP panel.

34. The single panel reflective-type color optical engine as claimed in claim 27, wherein each of said three primary color lights illuminates about ⅓ of said panel.
